(19) United States
(12) Patent Application Publication
(10) Pub. No.: US 2013/0309649 A1
(43) Pub. Date: Nov. 21, 2013

(54) METHOD FOR RATING ELECTRONIC BOOK

(71) Applicant: YINGQIDA INFORMATION CO., LTD., NEW TAIPEI CITY (TW)

(72) Inventors: PEI-HSUN TSAI, NEW TAIPEI CITY (TW); HAI-TAO WO, SHANGHAI CITY (CN); HIROSHI KAMIYAMA, TAIPEI CITY (TW)

(73) Assignee: YINGQIDA INFORMATION CO., LTD., NEW TAIPEI CITY (TW)

(21) Appl. No.: 13/684,288

(22) Filed: Nov. 23, 2012

(30) Foreign Application Priority Data
May 18, 2012 (TW) 101117742

(51) Int. Cl. G09B 25/00

(52) U.S. Cl. CPC G09B 25/00
USPC 434/367

(57) ABSTRACT

A method for rating electronic books (e-books) is revealed. Acquire and save an e-book in a memory device. Set up a criterion that includes at least one standard value and a plurality of regions defined by the standard value. Compile at least one electronic label corresponding to the region by an input device and save the electronic label in the memory device. The electronic label is linked to at least one electronic page of the e-book so that the electronic label is displayed with the electronic page when the e-book is retrieved by a reading device. The present invention can be applied to rating, copyright notice, and classification of e-books. The electronic labels in visual or audio form show messages related to e-book rating, copyright notice and classification.

### BACKGROUND OF THE INVENTION

1. Fields of the Invention

The present invention relates to a method for rating e-books, especially to a method for rating electronic books (e-books) in which an e-book is rated/categorized by a criterion and at least one electronic label is linked to at least one electronic page of the e-book to be displayed together with the e-page.

2. Descriptions of Related Art

In order to digitize and archive cultural works and encourage creation and distribution of e-books, Project Gutenberg, the oldest digital library was founded in 1971. A plurality of volunteers has joined the effort to digitalize works or literature whose intellectual property right have expired, or been forfeited and make them available in electronic form for free. There are nearly 40,000 books in Project Gutenberg now. For energy saving, carbon reduction, and environmental protection, e-book industry have received a great attention and listed on the Copenhagen concept stocks. This is a new chapter for the e-book industry.

With the fast development of internet and prevalence of cloud services, users get used to deliver and get access to information and knowledge in electronic form instead of papers. The reading habit change is driving the accelerated development of e-book industry. Besides the Project Gutenberg that offers free e-books to download mentioned above, there are a lot of large-scale online bookstores that not only sells paper books but also books in digital form. All these show growing demand for e-books.

Moreover, the access of e-books is no more restricted by using desktop computers. The development of portable electronics has made e-books become more popular. The digital books are available on e-book readers or other portable electronic such as smart phones, portable multi-media players, tablet computers, etc. Users can get access to books they easily no matter where they are. The portable electronics makes the access of e-books more convenient and this is beneficial to the development of e-books.

However, a large amount of e-books are easy to be accessed and read while the e-book industry is getting mature gradually. Refer to Chinese regulations governing the classification of publications and video tapes for protection of children and adolescence (youth), there are some articles including “People who publish and supply publications should rate the publications by themselves before publishing and supplying the publications according to these regulations” and “The cover of publications classified into the Restricted category should be labeled with following words “Restricted category: Not available to persons under the age of 18 years.””. The publishers or suppliers of e-books should rate the e-books and label the results respectively to promote the physical or mental development of children or adolescents and protect their interest in reading.

Furthermore, intellectual property rights of e-books are easy to be infringed due to low technical threshold of reproduction and easy spread of e-books through internet. Thus the e-books are added with copyright notices and warnings for reminding readers not to have illegal reproduction of the books and they are liable for infringement.

Thus the present invention provides a method for rating e-books in which a criterion includes at least one standard value and a plurality of regions that is defined by the at least one standard value firstly. Then contrast content of an e-book with the standard value to categorize the e-book into one of the regions. Then at least one electronic label corresponding to that region is linked to at least one electronic page of the e-book. When readers retrieve the electronic page in the e-book by reading devices, the electronic label is also displayed for reminding readers of something. The criterion is set up according to publishers' or suppliers' requirements and is able to be a rating criterion, a copyright standard, or a classification criterion. The electronic label corresponding to the criterion includes a rating message, a copyright notice or a classification message. And a warning label or a reminder message can also be added into the electronic label for delivering messages the publishers or the suppliers intend to inform readers. The method for rating e-books of the present invention can also be applied to copyright notice display or other classification criteria, not limited to the rating criterion of e-books governed by the government regulations.

The electronic label can be either in visual form such as a watermark, an electronic header, an electronic footer, or an electronic frame, or in audio form such as a voice reminder so as to remind readers or their custodian of something. Moreover, the electronic label can also be used as a classification criterion. Each e-book is sorted to at least one electronic shelf according to the electronic label. Thus e-books with different ratings, various copyright notices or different categories are managed or displayed conveniently.

### SUMMARY OF THE INVENTION

Therefore it is a primary object of the present invention to provide a method for rating e-books in which an e-book is rated or categorized by a criterion.

It is another object of the present invention to provide a method for rating e-books in which at least one electronic label is linked to at least one electronic page of an e-book. Thus the electronic label is shown together with the electronic page for reminding readers something while the e-book being retrieved.

It is a further object of the present invention to provide a method for rating e-books in which electronic labels are in visual form or in audio form so as to remind readers or their custodian of something important.

In order to achieve the above objects, a method for rating e-books according to the present invention includes a plurality of steps. In the beginning, get an e-book and store the e-book in a memory device. Further set up a criterion that includes at least one standard value and a plurality of regions defined by the standard value. Contrast content of the e-book with the standard value by a processor so as to categorize the e-book in one of the regions. Then compile at least one electronic label corresponding to the regions by an input device and save the electronic label in the memory device. Next link the electronic label to at least one electronic page of the e-book so that the electronic label is shown together with the electronic page while the e-book being retrieved by a reading device.

The criterion can be a rating criterion, a copyright notice standard, or a criterion for classification set up according to publishers' or suppliers' requirements. A standard value for rating, a standard value of copyright notice or a standard value for classification of children's book is also determined so as to define a plurality of regions correspondingly. Corresponding to the criterion, the electronic label includes a rating message, a copyright notice or a classification message. Thus the present invention can be applied to e-book rating, copyright notices or e-book classification. The electronic label can also include a warning label or a reminder message to remind readers of the rating results of the e-books or messages the publishers/suppliers would like to inform the readers such as they are liable for copyright infringement if the reproduction is unauthorized, the distribution is illegal or what is the appropriate age group for the e-book.

The electronic label can be either in visual form such as a watermark, an electronic header, an electronic footer, an electronic frame, etc., or in audio form such as a voice reminder. When the reader retrieves the corresponding electronic page, both the electronic label and the electronic page are displayed for reminding the reader or their custodian of something important. Thus the e-books are rated or categorized for protecting children's or adolescents' interest in reading. The reader is informed about the copyright ownership of the e-book and some specific messages from publishers or suppliers are delivered to the reader. Moreover, the e-books can be organized into at least one electronic shelf according to the electronic labels linked to the electronic page thereof for optimum management and display.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of an embodiment according to the present invention;

FIG. 2 is a schematic drawing showing component relationships of an embodiment according to the present invention;

FIG. 3 is a flow chart showing steps of another embodiment according to the present invention;

FIG. 4 is a schematic drawing showing component relationships of another embodiment according to the present invention;

FIG. 5 is a flow chart showing steps of a further embodiment according to the present invention;

FIG. 6 is a schematic drawing showing component relationships of a further embodiment according to the present invention;

FIG. 7 is a schematic drawing showing electronic labels of a further embodiment according to the present invention.

### DETAILED DESCRIPTION OF THE PREFERRED EMBODIMENT

A method for rating e-books of the present invention features on that a criterion is set up according to requirements of publishers or suppliers and is used to rate or categorize an e-book into a region. The e-book is contrasted with a standard value to be categorized in a region. Then at least one electronic label corresponding to the region is linked to at least one electronic page of the e-book. When a reader retrieves the e-book by a reading device, the electronic label and the electronic page are displayed at the same time so as to remind the reader of the rating result (region or category) of the e-book. The electronic label can be in visual or audio form and having messages related to e-book rating, copyright notices and e-book classification. The electronic label can also be added with warning labels or reminder messages. Besides reminding users, the electronic label can also be used by publishers or suppliers to organize e-books into different electronic shelves for convenient management or display.

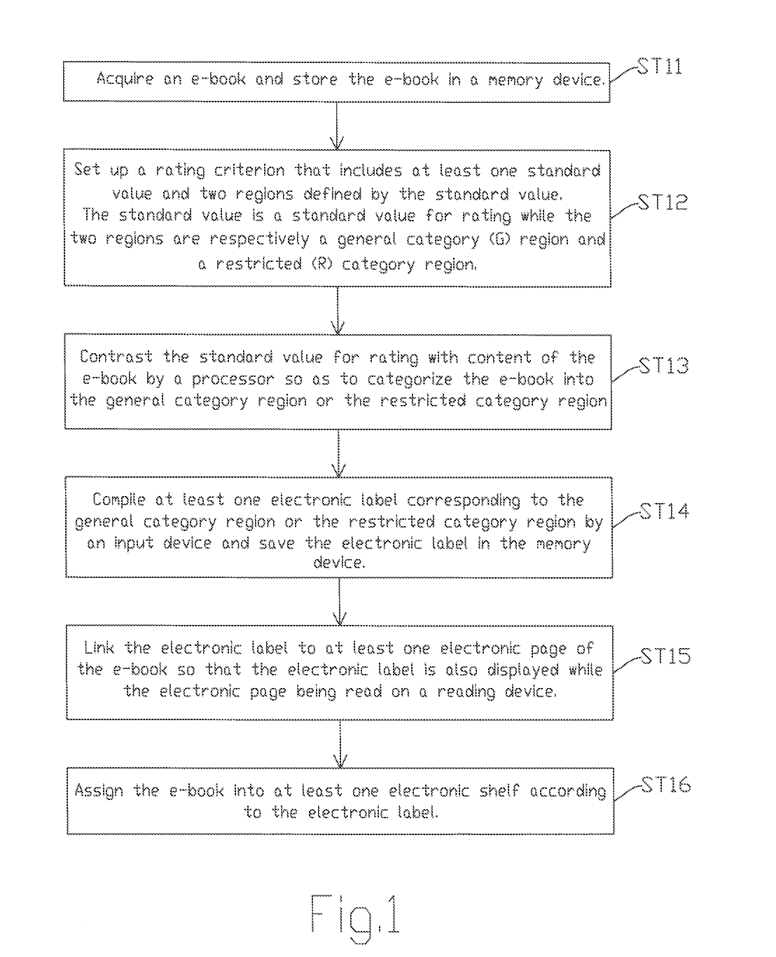

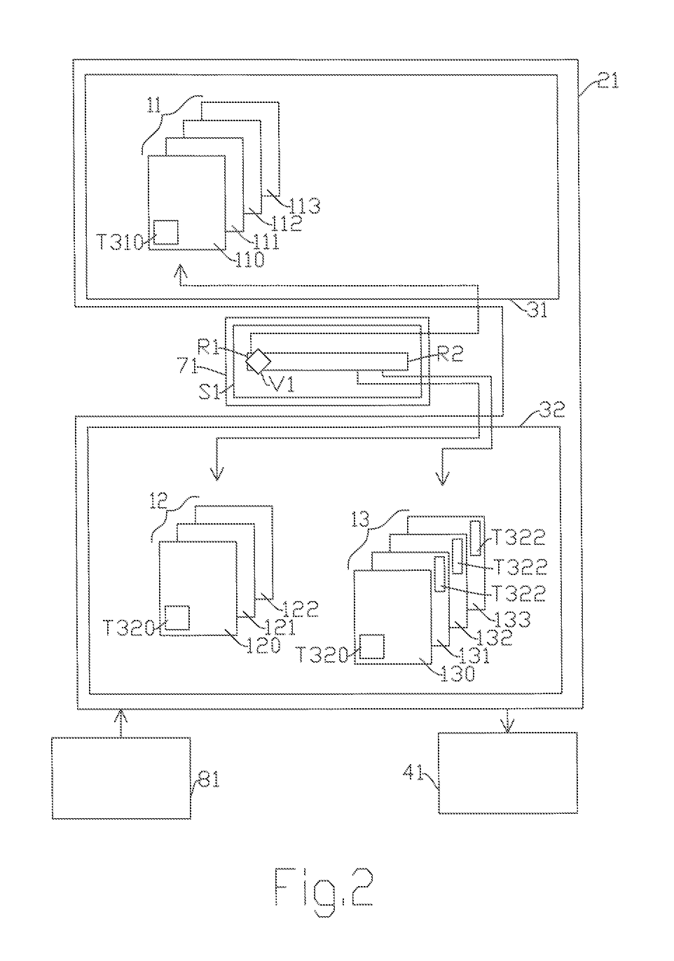

Refer to FIG. 1 and FIG. 2, a flow chart showing steps of an embodiment and a schematic drawing showing component relationship are revealed. As shown in FIG. 1, a method for rating e-books of the present invention includes following steps:
ST11: Acquire an e-book and store the e-book in a memory device.
ST12: Set up a rating criterion that includes at least one standard value and two regions defined by the standard value. The standard value is a standard value for rating while the two regions are respectively a general category (G) region and a restricted (R) category region.
ST13: Contrast the standard value for rating with content of the e-book by a processor so as to categorize the e-book into the general category region or the restricted category region.
ST14: Compile at least one electronic label corresponding to the general category region or the restricted category region by an input device and save the electronic label in the memory device.
ST15: Link the electronic label to at least one electronic page of the e-book so that the electronic label is also displayed while the electronic page being read on a reading device;
ST16: Assign the e-book into at least one electronic shelf according to the electronic label.

Refer to FIG. 2, a supplier acquires three e-books—a first e-book 11, a second e-book 12 and a third e-book 13. The first e-book 11 includes four electronic pages formed by a first electronic cover 110, a 1-1 electronic page 111, a 1-2 electronic page 112 and a 1-3 electronic page 113. The second e-book 12 consists of three electronic pages having a second electronic cover 120, a 2-1 electronic page 121, and a 2-2 electronic page 122. The third e-book 13 includes four electronic pages formed by a third electronic cover 130, a 3-1 electronic page 131, a 3-2 electronic page 132 and a 3-3 electronic page 133. All these e-books 11, 12 and 13 are stored in a memory device 21.

A rating criterion S1 is set up by the supplier and used for rating. The rating criterion S1 includes a standard value V1 and two regions R1, R2 defined by the standard value V1. The standard value V1 is a standard value for rating V1 and the two regions are respectively a general category region R1 and a restricted category region R2. The standard value for rating V1 means that a ratio of words involving violence, crime or sex in content of an e-book is zero. If the ratio of the words involving violence, crime or sex in the e-book is equal to the standard value for rating V1, the e-book is categorized in the general category region R1. Once the ratio of the words involving violence, crime or sex in an e-book is larger than the standard value for rating V1, the e-book is sorted to the restricted category region R2. The supplier uses a processor 71 to contrast the standard value for rating V1 with content of the e-books 11, 12 and 13. Then the first e-book 11 is classified into the general category region R1 while the second and the third e-books 12, 13 are categorized in the restricted category region R2.

Next the supplier uses an input device 81 to compile three rating messages T310, T320, and T322 that are corresponding to the general category region R1 and the restricted category region R2 respectively and used as electronic labels. A G-rated cover label T310 and an R-rated cover label T320 belong to electronic labels in visual form while an R-rated page label T322 is a voice reminder, an electronic label in audio form. The electronic labels T310, T320, and T322 are saved in the memory device 21. According to the rating results, the supplier links the G-rated cover label T310 to the first electronic cover 10, links the R-rated cover label T320 to both the second electronic cover 120 and the third electronic cover 130, and links the R-rated page label T322 to the 3-1 electronic page 131, the 3-2 electronic page 132 and the 3-3 electronic page 133.

The e-books 11, 12 and 13 are assigned to two electronic shelves 31, 32 by the supplier according to the electronic labels T310, T320, and T322. Thus the first e-book 11 is contained in a G-rated electronic shelf 31 while the second e-book 12 and the e-book 13 are contained in a R-rated electronic shelf 32. Therefore the supplier can manage and display these e-books 11, 12 and 13 easily and conveniently.

When a reader selects the first e-book 11 and retrieves the first electronic cover 110 by a reading device 41, the G-rated cover label T310 is also shown to make the reader know that the first e-book 11 is a G-rated e-book. Similarly, the R-rated cover label T320 is also displayed when the user selects the second e-book 12 or the third e-book 13 and reads the second electronic cover 120 or the third electronic cover 130. Thus the user learns that the second e-book 12 or the third e-book 13 is categorized in the restricted category. When the reader continues to read the 3-1 electronic page 131, the 3-2 electronic page 132 or the 3-3 electronic page 133 of the third e-book 13, the R-rated page label T322 in audio form is displayed along with the electronic page 131, 132, or 133 so as to remind the read the book he/she is reading is R-rated.

The rating criterion S1 is set up according to the requirements of the supplier and used for rating the e-books 11, 12 and 13 into the general category region R1 or the restricted category region R2. Moreover, the rating messages T310, T320, and T322 are compiled and respectively linked to the first electronic cover 110, the second electronic cover 120, the third electronic cover 130, and the electronic pages ranging from 3-1 to 3-3 131, 132, 133. Thus the rating messages T310, T320, and T322 are displayed while the reader retrieving the above electronic covers and pages so as to remind the user of the rating results of the e-books 11, 12 and 13. The R-rated page label T322 to be displayed is in audio form and this is for better reminding guardians of minor readers.

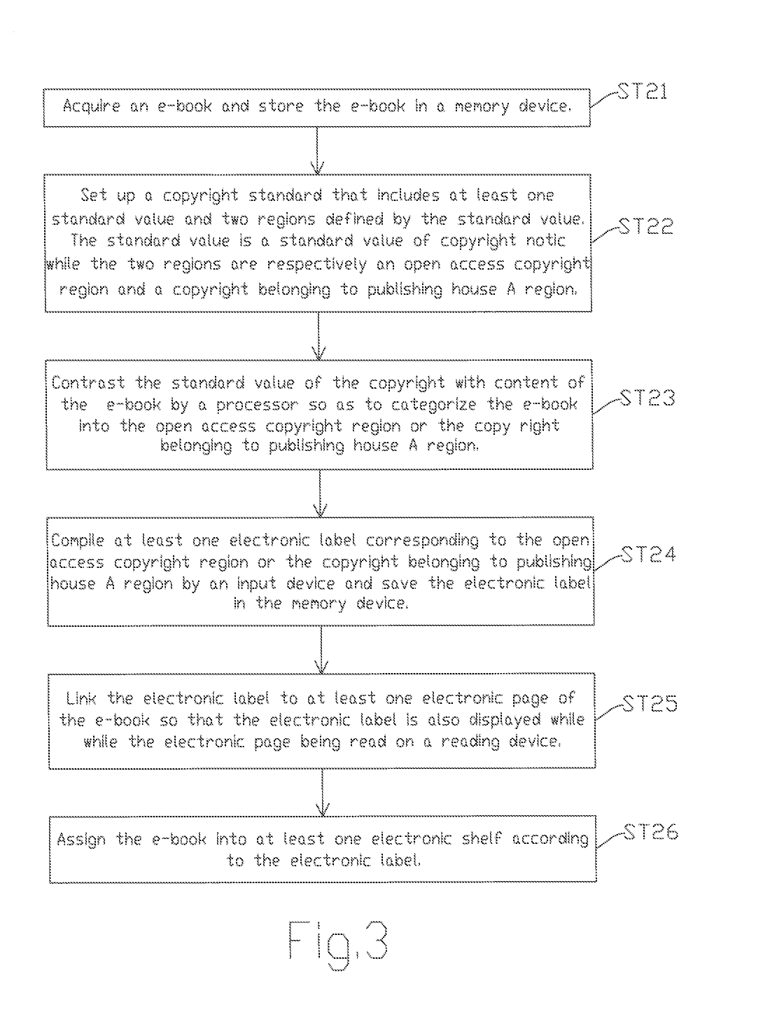

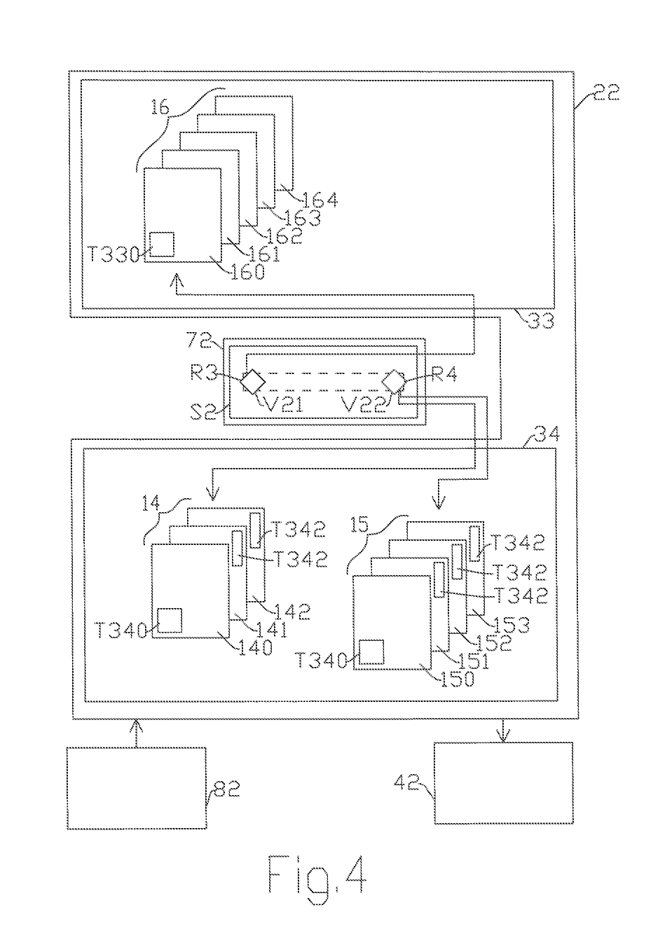

Refer to FIG. 3 and FIG. 4, a flow chart showing steps of another embodiment and a schematic drawing showing component relationship are revealed. As shown in FIG. 3, a method for rating e-books of the present invention includes following steps:
ST21: Acquire an e-book and store the e-book in a memory device.
ST22: Set up a copyright standard that includes at least one standard value and two regions defined by the standard value. The standard value is a standard value of copyright notice while the two regions are respectively an open access copyright region and a copyright belonging to publishing house A region.
ST23: Contrast the standard value of the copyright with content of the e-book by a processor so as to categorize the e-book into the open access copyright region or the copy right belonging to publishing house A region.
ST24: Compile at least one electronic label corresponding to the open access copyright region or the copyright belonging to publishing house A region by an input device and save the electronic label in the memory device.
ST25: Link the electronic label to at least one electronic page of the e-book so that the electronic label is also displayed while the electronic page being read on a reading device;
ST26: Assign the e-book into at least one electronic shelf according to the electronic label.

As shown in the FIG. 4, a supplier obtains three e-books—a fourth e-book 14, a fifth e-book 15 and a sixth e-book 16. The fourth e-book 14 includes three electronic pages formed by a fourth electronic cover 140, a 4-1 electronic page 141, and a 4-2 electronic page 142. The fifth e-book 15 consists of four electronic pages having a fifth electronic cover 150, a 5-1 electronic page 151, and a 5-2 electronic page 152, and a 5-3 electronic page 153. The sixth e-book 16 includes five electronic pages formed by a sixth electronic cover 160, a 6-1 electronic page 161, a 6-2 electronic page 162 and a 6-3 electronic page 163, and a 6-4 electronic page 164. All these e-books 14, 15 and 16 are saved in a memory device 22.

A copyright standard S2 is set up by the supplier and used for determining copyright ownership. The copyright standard S2 includes two standard values V21, V22 and two regions R3, R4 defined by the two standard values V21, V22. The two standard values V21, V22 are standard values of copyright notice and the two regions are respectively an open access copyright region R3 and a copyright belonging to publishing house A region R4. The standard value V21 represents that the value of the copyright of an e-book is zero and copyright has been expired or forfeited. Once the value of the copyright of an e-book is equal to the standard value V21, the e-book is classified into the open access copyright region R3. The standard value V22 represents that the value of the copyright of an e-book is one. That means the intellectual property (copyright) of the e-book belongs to the publishing house A. If the value of the copyright of an e-book is equal to the standard value V22, the e-book is categorized in the copyright belonging to publishing house A region R4. The supplier uses a processor 72 to contrast the two standard values V21, V22 and content of the e-books 14, 15 and 16. Then the sixth e-book 16 is sorted into the open access copyright region R3 while the fourth and the fifth e-books 14, 15 are classified into the copyright belonging to publishing house A region R4.

The supplier uses an input device 72 to compile three electronic labels T330, T340, and T342 that are corresponding to the open access copyright region R3 and the copyright belonging to publishing house A region R4. The electronic labels T330, T340 are copyright notices. T330 is a label of open access copyright and T340 is a label showing that copyright belongs to publishing house A. As to the T342, it's a warning label—“copyright all right reserved”. The three electronic bales T330, T340, and T342 are all in visual form and saved in the memory device 22. According to results of the above process, the supplier links the label of open access copyright label T330 to the sixth electronic cover 160. Similarly, the copyright belonging to publishing house A label T340 is linked to the fourth electronic cover 140 and the fifth electronic cover 150. The warning label T342 is linked to the 4-1 electronic page 141, the 4-2 electronic page 142, the 5-1 electronic page 151, the 5-2 electronic page 152, and the 5-3 electronic page 153.

By the electronic labels T330, T340 and T342, the supplier assigns the e-books 14, 15, and 16 into two electronic shelves 33, 34. The sixth e-book 16 is set in an open access copyright electronic shelf 33 while the fifth e-book 15 and the fourth e-book 14 are contained in the electronic shelf of the publishing house A's copyright 34. Thus the supplier can manage and display the e-books 14, 15, 16 conveniently.

When a reader selects the fourth e-book 14/or the fifth e-book 15 and retrieves the fourth electronic cover 140/or the fifth electronic cover 150 by a reading device 42, the copyright belonging to publishing house A label T340 is also displayed to inform the reader that the copyright of the fourth e-book 14/or the fifth e-book 15 belongs to the publishing house A. When the reader continues to read the 4-1 electronic page 141, the 4-2 electronic page 142, the 5-1 electronic page 151, the 5-2 electronic page 152, or the 5-3 electronic page 153 of the fourth e-book 14/the fifth e-book 15, the warning label T342 is displayed along with the electronic page 141, 142, 151, 152 or 153 being read to remind the reader that copyright of the fourth e-book 14/or the fifth e-book 15 belongs to the publishing house A. The reader must be aware that he is liable for what he does and any damages that may occur if they infringe copyright. When the reader chooses the sixth e-book 16 and gets the sixth electronic cover 160 by the reading device 42, the label of open access copyright T330 is also displayed. Thus the reader learns that the copyright of the sixth e-book 16 has been eliminated and he can make use of the sixth e-book 16 freely.

The copyright standard S2 is determined according to requirements of suppliers or publishers and is used for checking copyright ownership of the e-books 14, 15, and 16. The e-books 14, 15 and 16 are respectively classified into the open access copyright region R3 or the copyright belonging to publishing house A region R4 according to the standard values V21, V22. The electronic labels T330, T340 and T342 are respectively linked to the six electronic cover 160, the fourth electronic cover 140 and the fifth electronic cover 150, and the electronic pages 141, 142, 151, 152 and 153 so that the electronic labels T330, T340 and T342 are also displayed while the reader is retrieving these electronic covers or pages for reminding the users that the copyright of the e-book belong to which publishers (or individuals). The warning label T342 also reminds readers of their liabilities if they infringe other's intellectual property rights.

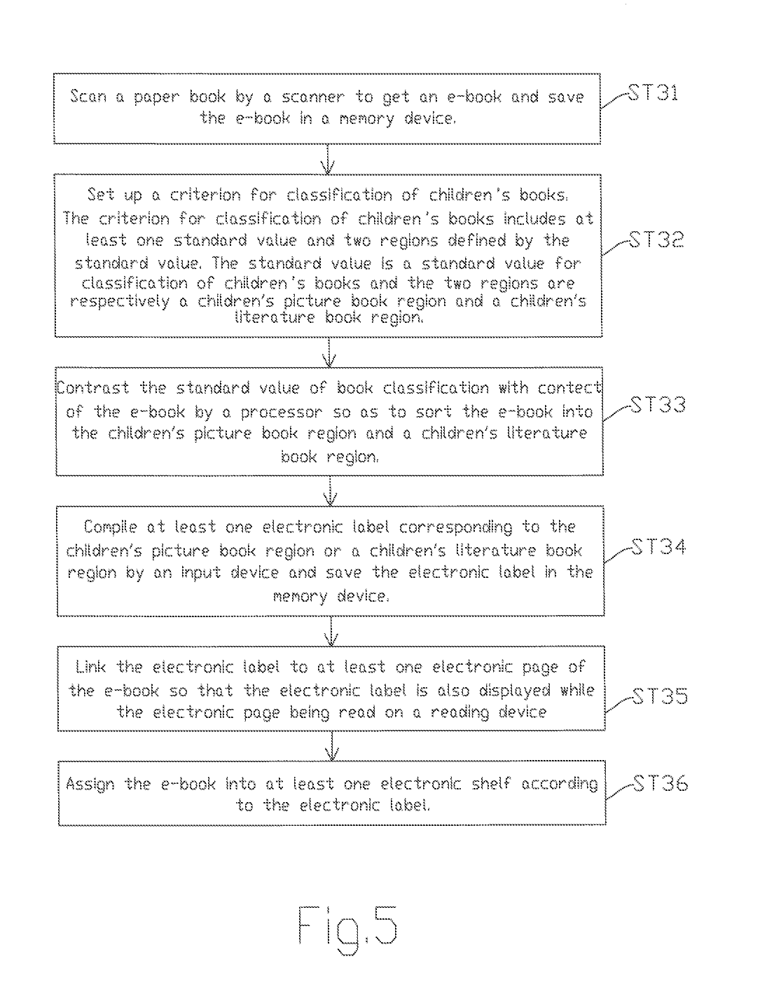

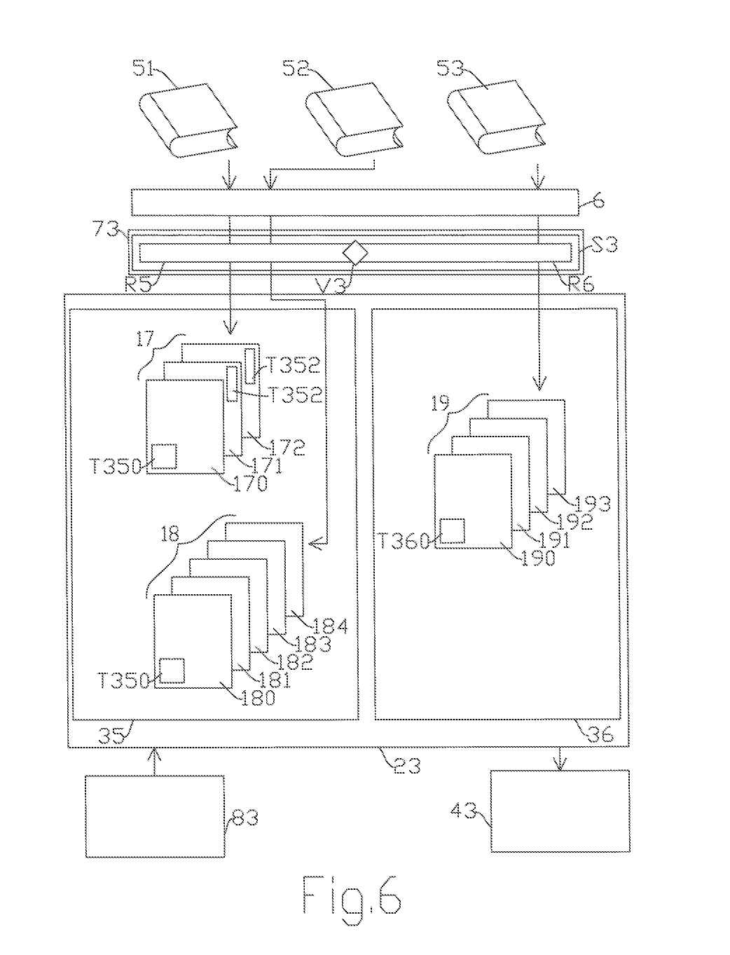

Refer to FIG. 5 and FIG. 6, a flow chart showing steps of a further embodiment and a schematic drawing showing component relationship are revealed. As shown in FIG. 5, a method for rating e-books of the present invention includes following steps
ST31: Scan a paper book by a scanner to get an e-book and save the e-book in a memory device.
ST32: Set up a criterion for classification of children's books. The criterion for classification of children's books includes at least one standard value and two regions defined by the standard value. The standard value is a standard value for classification of children's books and the two regions are respectively a children's picture book region and a children's literature book region.
ST33: Contrast the standard value of book classification with content of the e-book by a processor so as to sort the e-book into the children's picture book region and a children's literature book region.
ST34: Compile at least one electronic label corresponding to the children's picture book region or a children's literature book region by an input device and save the electronic label in the memory device.
ST35: Link the electronic label to at least one electronic page of the e-book so that the electronic label is also displayed while the electronic page being read on a reading device;
ST36: Assign the e-book into at least one electronic shelf according to the electronic label.

Refer to FIG. 6, a publisher scans a first paper book 51, a second paper book 52, and a third paper book 53 respectively by a scanner 6 to get a seventh e-book 17, a eighth e-book 18, and a ninth e-book 19. The seventh e-book 17 includes three electronic pages—a seventh electronic cover 170, a 7-1 electronic page 171, and a 7-2 electronic page 172. The eighth e-book 18 is formed by five electronic pages having a eighth electronic cover 180, a 8-1 electronic page 181, a 8-2 electronic page 182, a 8-3 electronic page 183, and a 8-4 electronic page 184.

The ninth e-book 19 consists of four electronic pages—a ninth electronic cover 190, a 9-1 electronic page 191, a 9-2 electronic page 192, and a 9-3 electronic page 193. The e-books 17, 18 and 19 are saved in a memory device 23.

After obtaining the e-books 17, 18 and 19 by scanning the paper books 51, 52, and 53, the publisher sets up a criterion for classification of children's books S3. The criterion for classification of children's books S3 includes a standard value V3 and two regions defined by the standard value V3. The standard value V3 is a standard value for classification of children's books V3 while the two regions are respectively a children's picture book region R5 and a children's literature book region R6. The standard value for classification of children's books V3 represents that pictures (or illustrations) in a children's book is over 50% of the total content. Once the ratio of pictures in an e-book is larger than the standard value for classification of children's books V3, the e-books is classified into the children's picture book region R5. If the ratio of pictures in an e-book is smaller or equal to (not larger than) the standard value for classification of children's books V3, the e-books is categorized in the children's literature book region R6. Then the publisher uses a processor 73 to contrast the standard value for classification of children's books V3 with content of the e-books 17, 18 and 19. Thus the seventh and the eighth e-books 17, 18 are categorized in the children's picture book region R5 while the ninth e-book 19 is classified into the children's literature book region R6.

Next an input device 83 is used by the publisher to compile three electronic labels T350, T352 and T360 corresponding to the children's picture book region R5 and the children's literature book region R6. The two labels T350 and T360 are respectively a label of picture books T350 and a label of literature books T360. As to the reminder label T352, it's labeled with “appropriate books for preschool children”. The three electronic labels T350, T352 and T360 are all in visual form and are also saved in the memory device 23. According to the classification results of children's books, the publisher links the label of picture books T350 to the seventh electronic cover 170 and the eighth electronic cover 180, links the reminder label T352 to the 7-1 electronic page 171 and the 7-2 electronic page 172, and links the label of literature books T360 to the ninth electronic cover 190.

By means of the electronic labels T350, T352 and T360, the publisher assigns the e-books 17, 18 and 19 to two electronic shelves 35, 36. The seventh e-book 17 and the eighth e-book 18 are set on the electronic shelf of picture books 35 while the ninth e-book 19 are assigned to the electronic shelf of literature books 36. Thus the publisher can manage the e-books 17, 18 and 19 conveniently.

When a reader selects and retrieves the seventh e-book 17 or the eighth e-book 18 by a reading device 43, the label of picture books T350 is also shown to inform the reader that the seventh e-book 17 or the eighth e-book 18 is a picture book. When the user continues to read the 7-1 electronic page 171 or the 7-2 electronic page 172 of the seventh e-book 17, the reminder label T352 is also displayed to remind the reader that the seventh e-book 17 is suitable for preschool children. While the reader selecting and reading the ninth e-book 19 by the reading device 43, the label of literature books T360 is displayed at the same time to let the reader know that the ninth e-book 19 is a children's literature book.

The criterion for classification of children's books S3 is set up according to the publisher's requirements and is used for classification of the e-books 17, 18 and 19. The books 17, 18 and 19 are categorized in the children's picture book region R5 or the children's literature book region R6 according to the standard value V3. The electronic labels T350, T352 and T360 are compiled and then linked to the seventh electronic cover 170 and the eighth electronic cover 180, the 7-1 electronic page 171 and the 7-2 electronic page 172, and the ninth electronic cover 190 respectively. Thus the electronic labels T350, T352 and T360 are also displayed when the reader retrieves the electronic pages so as to inform the reader the classification results of the e-book 17, 18 and 19.

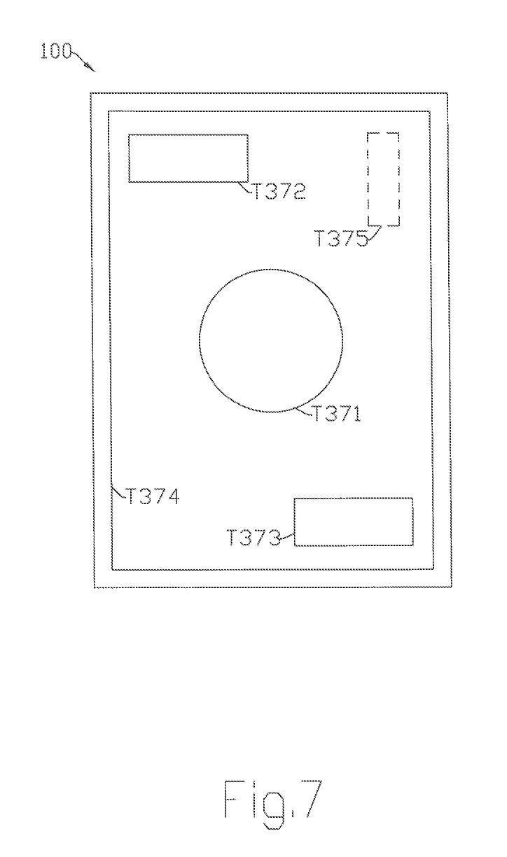

Refer to FIG. 7, a schematic drawing showing an electronic label of an embodiment according to the present invention is revealed. An electronic page 100 of the present invention includes a plurality of electronic labels T371, T372, T373, T374 and T375. The electronic label T371 is a watermark. The electronic label T372 is an electronic header. The electronic label T373 is an electronic footer. The electronic label T374 is an electronic frame and the electronic label T375 is a voice reminder. The watermark T371, the electronic header T372, the electronic footer 373, and the electronic frame T374 are electronic labels in visual form and are shown together with the electronic page 100 for reminding readers of something. The voice reminder T375 is in audio form and is also displayed together with the electronic page 100 for reminding readers of something.

Through the arrangement of these electronic labels T371, T372, T373, T374 and T375, the reader also gets visual or audio messages contained in these electronic labels while reading the electronic page 100.

In summary, a method for rating e-books of the present invention includes a plurality of steps. Acquire an e-book and store the e-book in a memory device. Set up a criterion according to users' needs. The criterion includes at least one standard value and a plurality of regions defined by the standard value. Thus the e-book is contrasted with the standard value of the criterion and then is categorized to one of the regions. At least one electronic label corresponding to the region categorized is compiled and saved in the memory device. The electronic label is linked to at least one electronic page of the e-book so that the electronic label is displayed together with the electronic page while the reader retrieving the e-book by a reading device. Moreover, the e-book can also be assigned into at least one electronic shelf according to the electronic label for convenient management or display. The present invention can be applied to e-book rating, copyright notice or classification. The copyright notices, rating and classification messages of e-books are shown in the electronic labels in visual or audio form.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for rating e-books comprising the steps of:
acquiring an e-book and storing the e-book in a memory device;
setting up a criterion that includes at least one standard value and at least two regions being defined by the standard value;
contrasting content of the e-book with the standard value by a processor so as to classify the e-book into one of the regions;
compiling at least one electronic label corresponding to the region by an input device and storing the electronic label in the memory device; and
linking the electronic label to at least one electronic page of the e-book so that the electronic label is displayed together with the electronic page while the e-book being retrieved by a reading device.

2. The method as claimed in claim 1, wherein the criterion is a rating criterion and the electronic label includes a rating message.

3. The method as claimed in claim 2, wherein the standard value is a standard value for rating and two regions are defined by the standard value for rating; the two regions are respectively a general category region and a restricted category region; the standard value for rating represents that a ratio of words involving violence, crime or sex in content of an e-book is zero; once a ratio of words involving violence, crime or sex in an e-book is larger than the standard value for rating, the e-book is classified into the restricted category region; if a ratio of words involving violence, crime or sex in the e-book is equal to the standard value for rating, the e-book is categorized in the general category region.

4. The method as claimed in claim 1, wherein the criterion is a copyright standard and the electronic label includes a copyright notice.

5. The method as claimed in claim 4, wherein the standard value is a standard value of copyright notice.

6. The method as claimed in claim 1, wherein the criterion is a criterion for classification and the electronic label includes a classification message.

7. The method as claimed in claim 6, wherein the standard value is a standard value for classification of children's books and two regions are defined by the standard value for classification of children's books; the two regions are respectively a children's picture book region and a children's literature book region; the standard value for classification of children's books represents that pictures in a children's book is over 50% of the total content; once a ratio of pictures in an e-book is larger than the standard value for classification of children's books, the e-books is classified into the children's picture book region; if a ratio of pictures in an e-book is not larger than the standard value for classification of children's books, the e-books is categorized in the children's literature book region.

8. The method as claimed in claim 1, wherein the electronic label includes a warning label.

9. The method as claimed in claim 1, wherein the electronic label is in visual form and is able to be a watermark, an electronic header, an electronic footer, or an electronic frame.

10. The method as claimed in claim 1, wherein the electronic label is in audio form and is a voice reminder.
